(19) United States
(12) Patent Application Publication
(10) Pub. No.: US 2026/0281469 A1
(43) Pub. Date: Sep. 17, 2026

(54) DUBBING GENERATION SYSTEM AND METHOD TO WHICH VOICE TECHNOLOGY BASED ON LINGUISTICS AND COGNITIVE SCIENCE IS APPLIED USING ARTIFICIAL INTELLIGENCE

(71) Applicants: AUNIONAI CO. LTD., Gwangju (KR); GWANGJU INSTITUTE OF SCIENCE AND TECHNOLOGY, Gwangju (KR)

(72) Inventors: Hong Kook KIM, Gwangju (KR); Midam KIM, Lawrence, KS (US)

(73) Assignees: AUNIONAI CO. LTD., Gwangju (KR); GWANGJU INSTITUTE OF SCIENCE AND TECHNOLOGY, Gwangju (KR)

(21) Appl. No.: 19/685,312

(22) Filed: May 22, 2026

Related U.S. Application Data
(63) Continuation of application No. PCT/KR2024/017832, filed on Nov. 12, 2024.

(30) Foreign Application Priority Data
Nov. 24, 2023 (KR) 10-2023-0165413

(51) Int. Cl. H04N 21/233; G10L 13/08; G10L 15/26

(52) U.S. Cl. CPC H04N 21/233; G10L 13/08; G10L 15/26

(57) ABSTRACT

The present disclosure relates to a dubbing generation system and method to which artificial intelligence-based voice technology is applied. The dubbing generation system according to the present disclosure comprises a server and a terminal, wherein the server comprises: a communication unit configured to receive video information from the terminal; and a processor including an artificial intelligence model for converting a voice signal included in the video information into text and generating dubbing information on the basis of the converted text, wherein the text is composed of international voice symbols.

### CROSS-REFERENCE TO RELATED APPLICATIONS

The present application is a continuation of International Patent Application No. PCT/KR2024/017832, filed on Nov. 12, 2024, which is based upon and claims the benefit of priority to Korean Patent Application No. 10-2023-0165413 filed on Nov. 24, 2023. The disclosures of the above-listed applications are hereby incorporated by reference herein in their entirety.

### BACKGROUND

Embodiments of the present disclosure described herein relate to a dubbing generation system, to which an AI-based voice technology is applied, and a method thereof.

Nowadays, a video streaming market related to a media content market is growing rapidly. Moreover, as the video streaming market expands from a domestic market to a global market, the need for dubbing generation technology is increasing.

In detail, in the growing media content market, individual creators are providing high-quality videos through dubbing generation to enhance their competitiveness. Accordingly, the market for dubbing generation services is expanding.

Currently, dubbing is generated by recording the result of translating the original language, so not only does it take a long time to produce, but also the meaning delivery power of dubbing may vary depending on the language and cultural understanding of a producer.

Furthermore, in the case of dubbing generation, it is difficult to convey the language and emotions of native speakers, which may make a video itself unnatural.

Accordingly, there is a need for a technology that is capable of reflecting the language and cultural differences of the country in which the original was produced and creating dubbing that is not unnatural even when the dubbing is inserted into a video.

### SUMMARY

Embodiments of the present disclosure provide a system and a method that are capable of generating natural dubbing that reflects language-specific characteristics, cultural differences between countries, and a speaker's emotions through artificial intelligence (AI).

According to an embodiment, a dubbing generation system includes a server and a terminal. The server includes a communication unit that receives video information from the terminal, and a processor including an artificial intelligence (AI) model that converts a voice signal included in the video information into text and generates dubbing information based on the converted text. The text is composed of International Phonetic Association (IPA).

In an embodiment, the processor may generate dubbing information about the voice information based on a translation result for the voice signal, and the converted text.

In an embodiment, based on the converted text, the processor may convert the translation result into information composed of IPA, and may generate dubbing information based on the converted information.

In an embodiment, the processor may remove the voice signal from the video information and may combine the dubbing information.

In an embodiment, the AI model may be a transformer.

According to an embodiment, a dubbing generation method of a dubbing generation system including a server and a terminal includes receiving, by the server, video information from the terminal, converting, by the server, a voice signal included in the video information into text, and generating, by the server, dubbing information based on the converted text. The text is composed of IPA.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is an overall system diagram, according to an embodiment of the present disclosure;

FIG. 2 is a block diagram of a server included in a dubbing generation system, according to an embodiment of the present disclosure;

FIG. 3 is a block diagram of a terminal included in a dubbing generation system, according to an embodiment of the present disclosure;

FIG. 4 is a block diagram of a processor included in a dubbing generation system, according to an embodiment of the present disclosure;

FIG. 5 is a conceptual diagram illustrating a subtitle and dubbing providing service;

FIG. 6 is a flowchart of a method for generating dubbing by using International Phonetic Association (IPA), according to an embodiment of the present disclosure; and

FIG. 7 is a conceptual diagram illustrating an embodiment in which a dubbing generation system according to an embodiment of the present disclosure converts a voice signal into text composed of IPA.

### DETAILED DESCRIPTION

The same reference numerals denote the same elements throughout the present disclosure. The present disclosure does not describe all elements of embodiments. Well-known content in a technical field, to which the present disclosure belongs, or redundant content in which embodiments are the same as one another will be omitted. A term such as ‘unit, module, member, or block’ used in the specification may be implemented with software or hardware. According to embodiments, a plurality of ‘units, modules, members, or blocks’ may be implemented with one component, or a single ‘unit, module, member, or block’ may include a plurality of components.

Throughout this specification, when it is supposed that a portion is “connected” to another portion, this includes not only a direct connection, but also an indirect connection. The indirect connection includes being connected through a wireless communication network.

Furthermore, when a portion “comprises” a component, it will be understood that it may further include another component, without excluding other components unless specifically stated otherwise.

Throughout this specification, when it is supposed that a member is located on another member “on”, this includes not only the case where one member is in contact with another member but also the case where another member is present between two other members.

Terms such as ‘first’, ‘second’, and the like are used to distinguish one component from another component, and thus the component is not limited by the terms described above.

Unless there are obvious exceptions in the context, a singular form includes a plural form.

In each step, an identification code is used for convenience of description. The identification code does not describe the order of each step. Unless the context clearly states a specific order, each step may be performed differently from the specified order.

Hereinafter, operating principles and embodiments of the present disclosure will be described with reference to the accompanying drawings.

In this specification, a ‘system according to an embodiment of the present disclosure’ includes all various devices capable of providing results to a user by performing arithmetic processing. For example, the system according to an embodiment of the present disclosure may include all of a computer, a server device, and a portable terminal, or may be in any one form.

Here, for example, the computer may include a notebook computer, a desktop computer, a laptop computer, a tablet PC, a slate PC, and the like, which are equipped with a web browser.

The server device may be a server that processes information by communicating with an external device and may include an application server, a computing server, a database server, a file server, a game server, a mail server, a proxy server, and a web server.

For example, the portable terminal may be a wireless communication device that guarantees portability and mobility, and may include all kinds of handheld-based wireless communication devices such as a smartphone, a personal communication system (PCS), a global system for mobile communication (GSM), a personal digital cellular (PDC), a personal handyphone system (PHS), a personal digital assistant (PDA), International Mobile Telecommunication (IMT)-2000, a code division multiple access (CDMA)-2000, W-Code Division Multiple Access (W-CDMA), and Wireless Broadband Internet (WiBro) terminal, and a wearable device such as a timepiece, a ring, a bracelet, an anklet, a necklace, glasses, a contact lens, or a head-mounted device (HMD).

Hereinafter, a dubbing generation system according to an embodiment of the present disclosure is described.

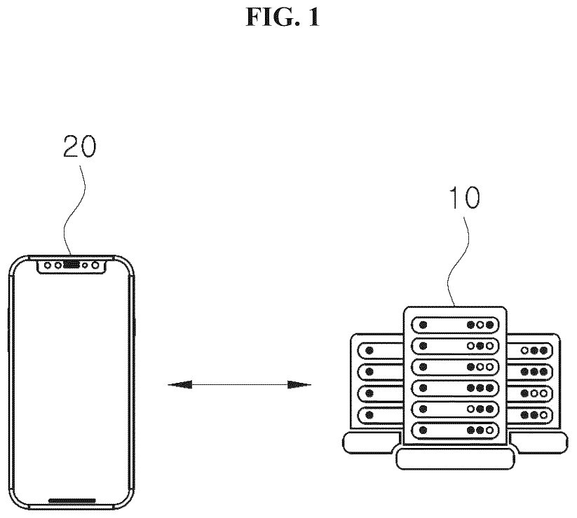

Referring to FIG. 1, the dubbing generation system according to an embodiment of the present disclosure may include at least one of a server 10 and a terminal 20. Specifically, the dubbing generation system according to an embodiment of the present disclosure may be implemented solely by the server 10 or the terminal 20, or may be implemented in a system form including at least one of the server 10 and the terminal 20. The description of the dubbing generation system described below may apply to both a case where the dubbing generation system according to an embodiment of the present disclosure may be implemented solely by the server 10 or the terminal 20, and a case where it may be implemented in a system form including at least one of the server 10 and the terminal 20.

The server 10 is connected to at least one terminal 20 via a network, transmits information to each of the plurality of terminals, and generates data necessary for dubbing generation learning based on information received from at least one of the terminal 20.

In the meantime, the terminal 20 is not limited to the above-described portable terminal. For example, it is obvious to those skilled in the art that the terminal 20 may include a processor-equipped notebook, desktop, laptop, tablet PC, slate PC, or the like.

Hereinafter, the server 10 and the terminal 20 for implementing the dubbing generation system according to an embodiment of the present disclosure are described.

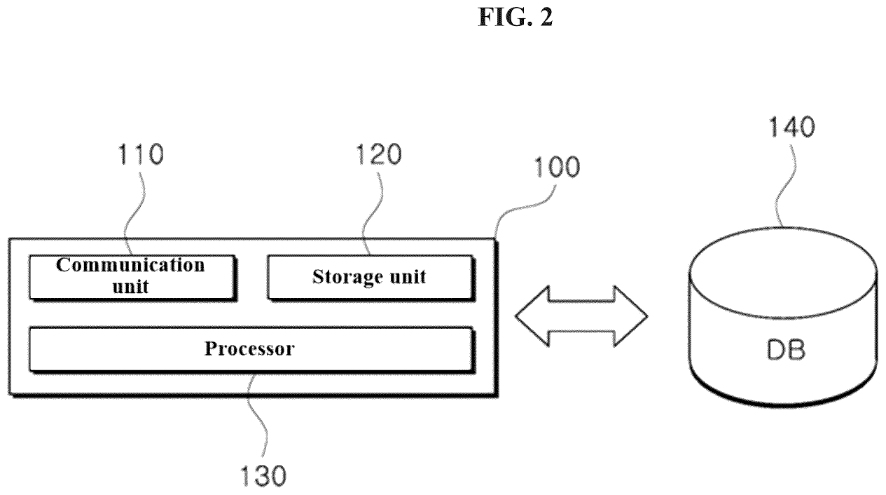

FIG. 2 is a block diagram of a server included in a dubbing generation system, according to an embodiment of the present disclosure.

A server 100 according to an embodiment of the present disclosure may include at least one of a communication unit 110, a storage unit 120, and a processor 130.

The communication unit 110 may communicate with at least one of a terminal, external storage (e.g., a database 140), an external server, and a cloud server.

In the meantime, the external server or the cloud server may be configured to perform at least part of the role of the processor 130. In other words, data processing or data operations may be performed by an external server or a cloud server, and the present disclosure does not place any special restrictions on this method.

Meanwhile, the communication unit 110 may support various communication methods according to the communication standards of a communicating target (e.g., an electronic device, an external server, a device, etc.).

For example, the communication unit 110 may be configured to communicate with a communication target by using at least one of wireless LAN (WLAN), Wireless-Fidelity (Wi-Fi), Wi-Fi Direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), 5th Generation (5G) Mobile Telecommunication, Bluetooth™, Radio Frequency Identification (RFID), Infrared Data Association (IrDA), Ultra-Wideband (UWB), ZigBee, Near Field Communication (NFC), and Wireless Universal Serial Bus (Wireless USB) technologies.

Next, the storage unit 120 may be configured to store various pieces of information related to the present disclosure. In an embodiment of the present disclosure, the storage unit 120 may be provided in the device itself according to an embodiment of the present disclosure. Unlike the above description, at least part of the storage unit 120 may refer to at least one of the database (DB) 140 and cloud storage (or a cloud server). In other words, it may be understood that the storage unit 120 is sufficient as a space for storing information necessary for the device and the method according to an embodiment of the present disclosure, and there are no restrictions on physical space. Accordingly, hereinafter, the storage unit 120, the database 140, the external storage, and the cloud storage (or the cloud server) may not be separately distinguished from each other, and may all be referred to as the “storage unit 120”.

Next, the processor 130 may be configured to control the overall operations of the device related to the present disclosure. The processor 130 may process a signal, data, information, or the like, which is input or output through the above-described components, or may provide or process information or functions suitable for user.

The processor 130 may include at least one central processing unit (CPU) and may perform functions according to an embodiment of the present disclosure.

At least one component may be added or deleted in response to the performance of the components illustrated in FIG. 2. Furthermore, it will be easily understood by those skilled in the art that mutual locations of the components may be changed to correspond to the performance or structure of the device.

Hereinafter, the terminal included in the dubbing generation system according to an embodiment of the present disclosure will be described in detail.

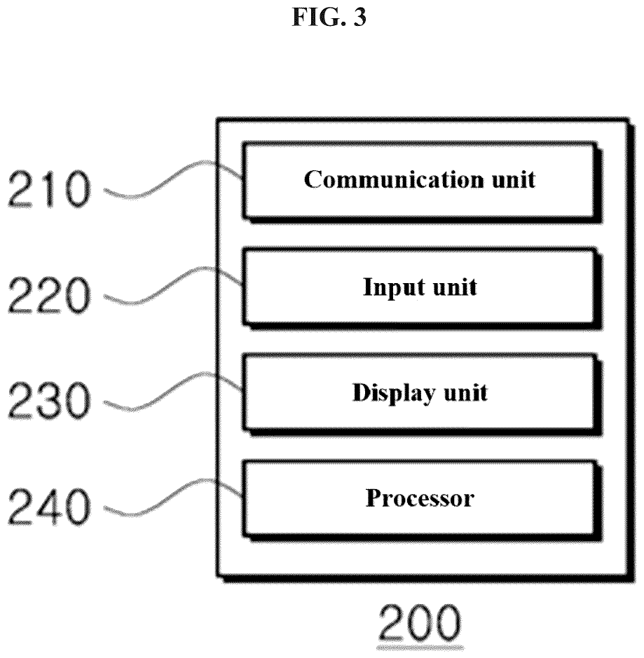

FIG. 3 is a block diagram of a terminal included in a dubbing generation system, according to an embodiment of the present disclosure.

Referring to FIG. 3, a terminal 200 according to an embodiment of the present disclosure may include a communication unit 210, an input unit 220, a display unit 230, and a processor 240. The components shown in FIG. 3 are not essential in implementing a dubbing generation system according to an embodiment of the present disclosure. The terminal described herein may have more or fewer components than those listed above.

The communication unit 210 among the components may include one or more components capable of communicating with an external device, and may include, for example, at least one of a broadcast reception module, a wired communication module, a wireless communication module, a short-range communication module, and a location information module.

Here, in addition to various wired communication modules such as a Local Area Network (LAN) module, a Wide Area Network (WAN) module, or a Value Added Network (VAN) module, the wired communication module may include a variety of cable communication modules such as Universal Serial Bus (USB), High Definition Multimedia Interface (HDMI), Digital Visual Interface (DVI), recommended standard 1302 (RS-1302), power line communication, or plain old telephone service (POTS).

Here, the wireless communication module may include a wireless communication module for supporting various wireless communication methods such as Global System for Mobile (GSM) communication, Code Division Multiple Access (CDMA), Wideband Code Division Multiple Access (WCDMA), Universal Mobile Telecommunication System (UMTS), Time Division Multiple Access (TDMA), Long Term Evolution (LTE), 4G, 5G, and 6G in addition to a Wi-Fi module and Wireless broadband module.

The input unit 220 may be used to enter image information (or signal), audio information (or signal), data, or information entered by a user. The input unit 220 may include at least one of at least one camera, at least one microphone, and a user input unit. Speech data or image data collected by the input unit may be analyzed and processed as a control command of a user.

The display unit 230 may include at least one of a display unit, a sound output unit, a haptic module, and an optical output unit, which are used to generate an output associated with visual, auditory, or tactile sensation. The display unit may have a mutual layer structure with a touch sensor or may be integrally formed with the touch sensor, thereby implementing the touch screen. Such the touch screen may provide an output interface between the present device and a user as well as operating as a user input unit that provides an input interface between the present device and the user.

The display unit displays (outputs) information processed by the present device. For example, the display may display execution screen information of an application program (e.g., an application) running on the present device, or a user interface (UI) or graphical user interface (GUI) information according to such the execution screen information.

In addition to the components described above, the terminal described above may further include an interface unit and a memory.

The interface unit serves as a passage for various types of external devices connected to the present device. The interface unit may include at least one of a wired/wireless headset port, an external charger port, a wired/wireless data port, a memory card port, a port for connecting a device equipped with a subscriber identification module (SIM), an audio input/output (I/O) port, a video I/O port, and an earphone port. In the present device, appropriate control related to an external device connected to the interface unit may be performed.

The memory may store data for supporting various functions of the present device, and a program for operations of the processor, may store pieces of input/output data (e.g., music files, still images, videos, and the like), and may store a plurality of application programs (or applications) running on the present device, pieces of data for operations of the present device, and instructions. At least part of the application programs may be downloaded from an external server through wireless communication.

The memory may include the type of a storage medium of at least one of a flash memory type, a hard disk type, a Solid State Disk (SSD) type, a Silicon Disk Drive (SDD) type, a multimedia card micro type, a memory of a card type (e.g., SD memory, XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. Furthermore, the memory may be separate from the present apparatus, but may be a database connected by wire or wirelessly.

In the meantime, the above-described terminal includes the processor 240. The processor may be implemented with a memory that stores data regarding an algorithm for controlling operations of components within the present device, or a program for implementing the algorithm, and at least one processor (not shown) that performs the above-described operations by using the data stored in the memory. At this time, the memory and the processor may be implemented as separate chips. Alternatively, the memory and the processor may be implemented as a single chip.

Meanwhile, to implement various embodiments of the present disclosure to be described below in the drawing, the processor may control one of the components described above or the combination of the components.

In the meantime, at least one component may be added or deleted to correspond to the performance of the components illustrated in FIGS. 1 to 3. Furthermore, it will be easily understood by those skilled in the art that mutual locations of the components may be changed to correspond to the performance or structure of the device.

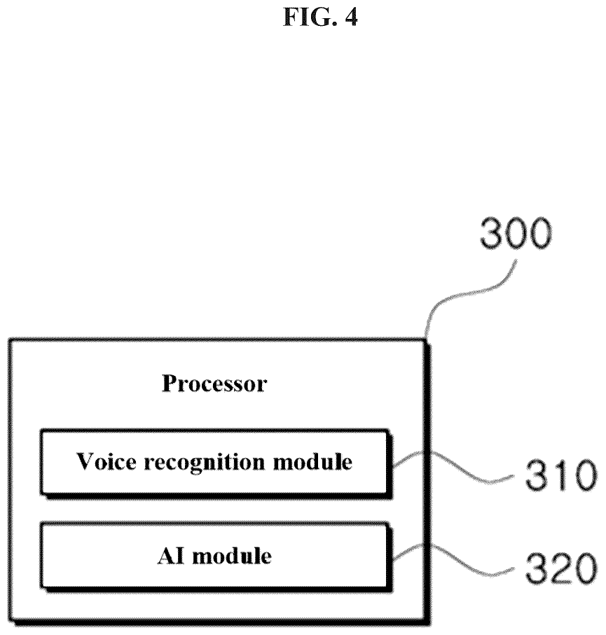

Meanwhile, as illustrated in FIG. 4, the processor included in at least one of the server and the terminal may include a plurality of modules for implementing a dubbing generation system to be described later. In particular, a processor 300 may include a voice recognition module 310 and an AI module 320. A dubbing generating method to be described below is described as being implemented by operations of the modules, but the performance of an operation at each step to be described below does not necessarily have to be performed by the modules.

Hereinafter, the artificial intelligence described in the present disclosure is described in detail.

Functions related to the artificial intelligence according to an embodiment of the present disclosure are operated through a processor and a memory, which are installed in the server and the terminal. The processor may consist of one or more processors. In this case, the one or more processors may be a general-purpose processor (e.g., a CPU, an AP, or a digital signal processor (DSP)), a graphics-dedicated processor (e.g., a GPU or a vision processing unit (VPU)), or an artificial intelligence (AI)-dedicated processor (e.g., an NPU). Under control of the one or more processors, input data may be processed depending on an AI model, or a predefined operating rule stored in the memory. Alternatively, when the one or more processors are AI-dedicated processors, the AI-dedicated processor may be designed with a hardware structure specialized for processing a specific AI model.

The predefined operating rule or the AI model is created through learning. Here, being created through learning means creating the predefined operating rule or the AI model configured to perform desired features (or purposes) as a basic artificial intelligence model is learned by using pieces of learning data by a learning algorithm. This learning may be performed by a device itself, on which the artificial intelligence according to an embodiment of the present disclosure is performed, or may be performed through a separate server and/or system. For example, the learning algorithm may include supervised learning, unsupervised learning, semi-supervised learning, or reinforcement learning, but may not be limited to the above example.

An artificial intelligence model may be composed of a plurality of neural network layers. The plurality of neural network layers respectively have a plurality of weight values, and each of the plurality of neural network layers performs neural network calculation through calculations between the calculation result of the previous layer and the plurality of weight values. The plurality of weight values of the plurality of neural network layers may be optimized by the learning result of the artificial intelligence model. For example, during a learning process, the plurality of weight values may be updated such that a loss value or a cost value obtained from the artificial intelligence model is reduced or minimized. The artificial neural network may include a deep neural network (DNN). The artificial neural network may be, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, but is not limited to the above-described example.

According to an embodiment of the present disclosure, a processor may implement artificial intelligence. The artificial intelligence may refer to an artificial neural network-based machine learning method that allows a machine to perform training by simulating human biological neurons. The methodology of artificial intelligence may be classified as supervised learning, in which a solution (output data) to a problem (input data) is determined by providing input data and output data together as training data depending on a learning method, unsupervised learning, in which only input data is provided without output data, and thus the solution (output data) to the problem (input data) is not determined, and reinforcement learning, in which a reward is given from an external environment whenever an action is taken in a current state, and thus learning progresses to maximize this reward. Moreover, the methodology of artificial intelligence may also be categorized depending on architecture, which is the structure of the learning model. The architecture of deep learning technology widely used may be categorized into convolutional neural networks (CNN), recurrent neural networks (RNN), transformers, and generative adversarial networks (GAN).

Each of the present device and the system may include an artificial intelligence model. The artificial intelligence model may be a single artificial intelligence model or may be implemented as a plurality of artificial intelligence models. The artificial intelligence model may be composed of neural networks (or artificial neural networks) and may include a statistical learning algorithm that mimics biological neurons in machine learning and cognitive science. The neural network may refer to a model as a whole having the ability to solve problems as artificial neurons (nodes), which form a network by connecting synapses, changes the strength of their synaptic connections through learning. Neurons in the neural network may include the combination of weight values or biases. The neural network may include one or more layers consisting of one or more neurons or nodes. For example, the present device may include an input layer, a hidden layer, and an output layer. The neural network constituting the present device may infer the result (output) to be predicted from an arbitrary input by changing a weight value of a neuron through learning.

The processor may create a neural network, may train or learn a neural network, or may perform operations based on received input data, and then may generate an information signal or may retrain the neural network based on the performed results. Models of a neural network may include various types of models such as a convolutional neural network (CNN) (e.g., GoogleNet, AlexNet, or VGG Network), a region with convolutional neural network (R-CNN), a region proposal network (RPN), a recurrent neural network (RNN), a stacking-based deep neural network (S-DNN), a state-space dynamic neural network (S-SDNN), a deconvolutional network, a deep belief network (DBN), a restricted Boltzmann machine (RBM), a fully convolutional network, a long short-term memory (LSTM) Network, and a classification network, but is not limited thereto. The processor may include one or more processors for performing computations according to the models of the neural network. For example, the neural network may include a deep neural network.

It will be understood by those skilled in the art that a neural network may include any neural network, but is not limited to a convolutional neural network (CNN), a recurrent neural network (RNN), a perceptron, a multilayer perceptron, a feed forward (FF), a radial basis network (RBF), a deep feed forward (DFF), a long short term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and an attention network (AN).

According to an embodiment of the present disclosure, the processor may use various artificial intelligence structures and algorithms such as a convolution neural network (CNN) (e.g., GoogleNet, AlexNet, or VGG Network), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzman machine (RBM), a fully convolutional network, a long short-term memory (LSTM) Network, a classification network, Generative Modeling, eXplainable AI, Continual AI, Representation Learning, AI for Material Design, algorithms for natural language processing (e.g., BERT, SP-BERT, MRC/QA, Text Analysis, Dialog System, GPT-3, and GPT-4), algorithms for vision processing (e.g., Visual Analytics, Visual Understanding, Video Synthesis, and ResNet), algorithms for data intelligence (e.g., Anomaly Detection, Prediction, Time-Series Forecasting, Optimization, Recommendation, and Data Creation), but is not limited thereto. Hereinafter, an embodiment of the present disclosure will be described in detail with reference to the accompanying drawings.

Hereinafter, a subtitle and dubbing providing service, in which a dubbing generation system and method according to an embodiment of the present disclosure are provided, are described.

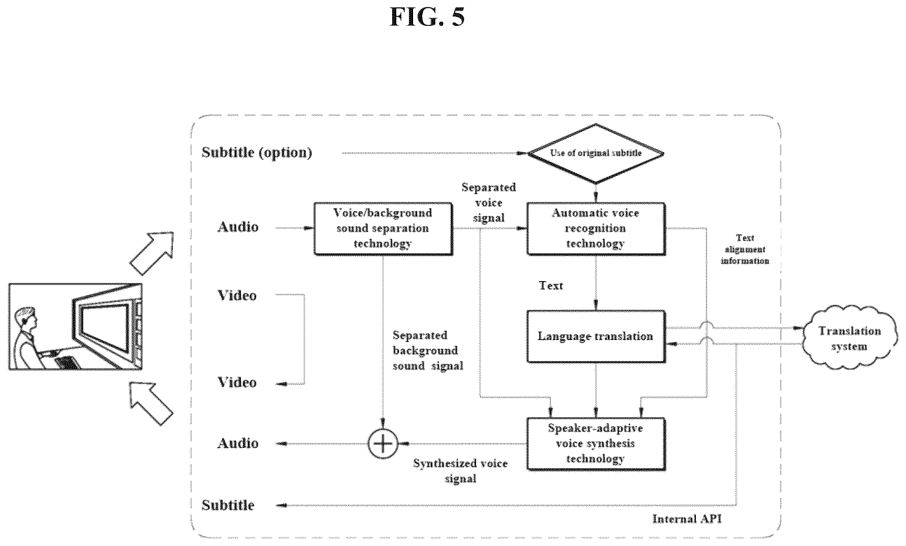

FIG. 5 is a conceptual diagram illustrating a subtitle and dubbing providing service.

Referring to FIG. 5, a step of receiving voice information is performed. Here, the step of receiving voice information may be a step of receiving video information. A subtitle dubbing generation system according to an embodiment of the present disclosure receives video information and utilizes the voice information included in the video information for dubbing generation. In contrast, the step of receiving the voice information may be a step of receiving the voice information itself rather than the video information.

In this specification, the voice information may include all pieces of data related to sound included in a video. In an embodiment, the voice information may include a voice signal and a background sound, which are included in the video information.

A processor receives the video information and processes the voice information included in the video information.

Next, a step of separating the voice signal and background sound information from the voice information is performed.

The processor may separate the voice signal and the background sound information from the voice information to create separate files.

The voice signal is the voice of a speaker included in the video information and is information that is the target of dubbing generation. Subsequently, the voice signal separated from the voice information is generated as at least one of pieces of dubbing.

The separation of the voice signal and the background sound information may be performed through a separate AI model trained to separate the voice signal and the background sound information from the voice information.

Next, a step of converting the separated voice signal into text is performed.

The voice signal may be converted into the text through the voice recognition module 310. Here, the text may consist of a language based on video production in which the voice signal is separated.

In this specification, the language based on video production is referred to as an “original language”, and the language used to generate dubbing is referred to as a “target language”.

Next, a step of translating the converted text in the original language into text in the target language is performed.

The translation result may be in the form of text in the target language and may be provided as a subtitle of the original video.

The type of the target language may be received from a video producer or a user watching a video.

In an embodiment, the video producer may specify the target language in advance and may generate subtitles for at least one target language from a video production stage.

In an embodiment, the video producer may not generate subtitles. Instead, a viewer watching a video may specify the target language to generate the subtitles. Subtitles created by a specific video viewer may be provided again to a video viewer who requests subtitles in the corresponding target language.

Afterwards, the translation results may be utilized for dubbing generation. This will be described later.

Meanwhile, the translation may be performed through a separate AI model trained to translate text in the original language into text in the target language. Here, the type of AI model for translation is not specifically limited thereto.

Meanwhile, the processor generates subtitles and then synthesizes the subtitles into the original video. In this case, the processor may set a time interval for inserting subtitles in consideration of the time interval in which a voice signal occurs within video information. Specifically, the processor may match the time interval in which the voice signal occurs within the video information in units of syllables, words, or sentences. The time information matched in this manner is also matched to the converted text after the voice signal is converted into text. Afterwards, the time information may also be matched to the result of translating the converted text. The processor may insert subtitles into the video information based on the time information.

Next, a step of generating a voice signal (hereinafter referred to as “dubbing information”) in a target language based on at least one of the separated voice signal, the converted text, and the translation result is performed.

The dubbing generation method according to an embodiment of the present disclosure may be implemented in the step of generating the voice signal described above.

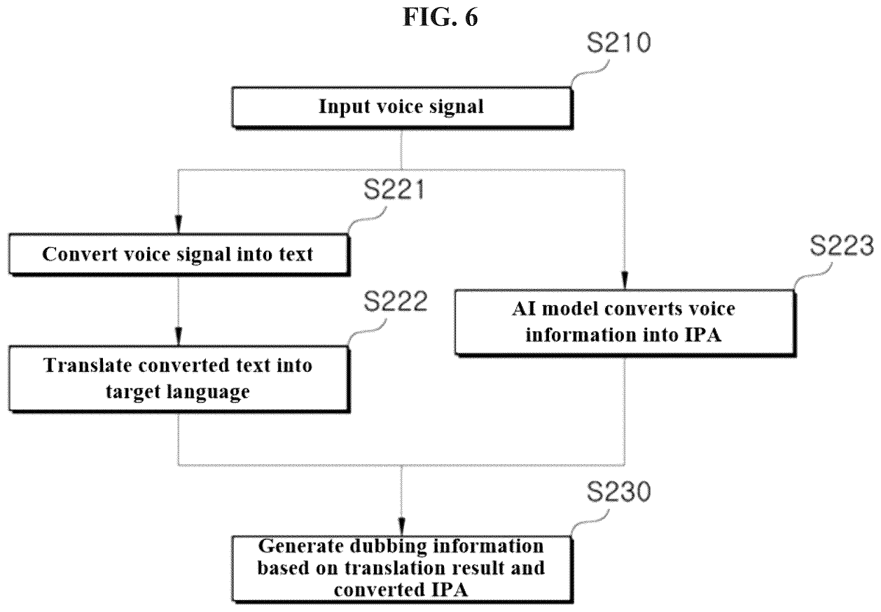

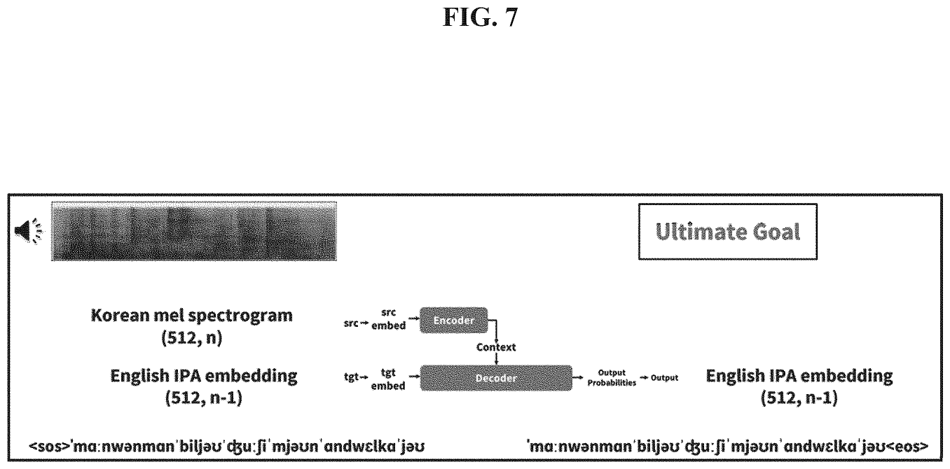

Hereinafter, a method for generating dubbing information in a target language will be described in detail with reference to FIGS. 6 and 7.

Referring to FIG. 6, the step in which the AI module 320 receives a voice signal proceeds (S210).

Here, the information received by the AI module 320 may be voice information included in video information, or may be a voice signal obtained by separating background sound information from the voice information.

Next, a step of converting the separated voice signal into text is performed (S221).

The voice signal may be converted into the text through the voice recognition module 310. Here, the text may consist of an original language.

Next a step of translating the converted text into a target language is performed (S222).

The converted text in the original language is converted into text in the target language through translation.

The translation may be performed through a previously disclosed AI model or may be performed through a separately trained AI model.

Steps S221 and S222 may be omitted by utilizing the translation results described in the subtitle and dubbing provision service described in FIG. 5.

Apart from the text translation, next, a step in which an AI model converts the voice signal into text composed of International Phonetic Association (IPA) is performed (S223).

The AI module 320 may include an AI model trained to convert voice information into IPA.

In an embodiment, the AI model may be a transformer, but is not limited thereto.

In an embodiment, referring to FIG. 7, the AI model receives voice information of “Could you lend me 10,000 won?” and converts it into IPA as shown below.

[symbol]

[symbol]

[symbol]

[symbol]

Specifically, the AI model may be trained such that ‘src’ is a voice signal composed of Korean, ‘tgt’ is an English IPA embedding, and an English IPA embedding becomes ‘output’.

Afterwards, the AI model generates dubbing information based on text composed of IPA, and the translation result (S230).

Specifically, the AI model may generate dubbing information about voice information based on the translation result for the voice signal, and the converted text.

Based on the converted text, the AI model converts the translation result into information composed of IPA. To this end, the AI model may be trained to receive the translation result of the voice signal in an original language and text composed of IPA based on a voice signal in the original language to generate the text, which is composed of IPA and translated into a target language. When IPA is utilized during a training process, dubbing information that reflects the regional, social, cultural, and linguistic differences between the original and target languages may be generated.

Moreover, as described above, when IPA are utilized during a process of training an AI model for generating dubbing information, dubbing information about the natural pronunciation of the target language may be generated.

Referring again to FIG. 5, a step of synthesizing the generated voice signal (dubbing information) with the separated background sound information is performed.

The processor may generate a subtitle for the video information by using the translation result, and may synthesize the generated voice signal with the separated background sound information by using the subtitle generation result.

Specifically, the processor may search for time information where the subtitle is output in the video information and may synthesize the generated voice signal with the separated background sound information by using the searched time information.

The processor may match the time interval in which the voice signal occurs within the video information in units of syllables, words, or sentences. The time information matched in this manner is also matched to the converted text after the voice signal is converted into text. Afterwards, the time information may also be matched to the result of translating the converted text. The processor may insert subtitles into the video information based on the time information. In addition, the processor may utilize the aforementioned time information for dubbing generation.

Meanwhile, the processor may synthesize the generated voice signal with the separated background sound information by using the result of separating the voice signal and the background sound information from the voice information included in the video information. In detail, the processor may synthesize the generated voice signal with the separated background sound information by using the time information where the voice signal was separated from the voice information.

When separating the voice signal from the background sound information, the processor may match information for defining the time interval, in which the voice signal is separated, to the background sound information. This time interval information may be defined in units of syllables, words, or sentences and may be matched to the background sound information. The time information may be utilized when dubbing information is synthesized with the background sound information.

As described above, according to the dubbing generation system according to an embodiment of the present disclosure, since the background sound separated from the voice information is synthesized after dubbing is generated, the dubbing may be generated without loss of sound source.

Furthermore, according to an embodiment of the present disclosure, the dubbing may be generated at a faster speed compared to conventional methods of generating dubbing manually.

Moreover, according to an embodiment of the present disclosure, it is possible to generate dubbing reflecting regional, social, cultural, and linguistic differences.

Meanwhile, the disclosed embodiments may be implemented in a form of a recording medium storing instructions executable by a computer. The instructions may be stored in a form of program codes, and, when executed by a processor, generate a program module to perform operations of the disclosed embodiments. The recording medium may be implemented as a computer-readable recording medium.

The computer-readable recording medium may include all kinds of recording media in which instructions capable of being decoded by a computer are stored. For example, there may be read only memory (ROM), random access memory (RAM), magnetic tape, magnetic disk, flash memory, optical data storage device, and the like.

Disclosed embodiments are described above with reference to the accompanying drawings. One ordinary skilled in the art to which the present disclosure belongs will understand that the present disclosure may be practiced in forms other than the disclosed embodiments without altering the technical ideas or essential features of the present disclosure. The disclosed embodiments are examples and should not be construed as limited thereto.

According to an embodiment of the present disclosure, it is possible to generate dubbing reflecting regional, social, cultural, and linguistic differences. Accordingly, a dubbing generation system according to an embodiment of the present disclosure may generate natural dubbing as if a native speaker says.

Moreover, according to an embodiment of the present disclosure, it is possible to produce dubbing at a high speed without the need for the speaker to record a voice for dubbing generation.

While the present disclosure has been described with reference to embodiments, it will be apparent to those skilled in the art that various changes and modifications may be made without departing from the spirit and scope of the present disclosure. Therefore, it should be understood that the above embodiments are not limiting, but illustrative.

What is claimed is:

1. A dubbing generation system including a server and a terminal, wherein the server includes:
a communication unit configured to receive video information from the terminal; and
a processor including an artificial intelligence (AI) model configured to convert a voice signal included in the video information into text and to generate dubbing information based on the converted text, and
wherein the text is composed of International Phonetic Association (IPA).

2. The system of claim 1, wherein the processor is configured to:
generate dubbing information about the voice signal based on a translation result for the voice signal, and the converted text.

3. The system of claim 2, wherein the processor is configured to:
based on the converted text:
convert the translation result into information composed of IPA; and
generate dubbing information based on the converted information.

4. The system of claim 3, wherein the processor is configured to:
remove the voice signal from the video information; and
combine the dubbing information.

5. The system of claim 4, wherein the AI model is a transformer.

6. A dubbing generation method of a dubbing generation system including a server and a terminal, the method comprising:
receiving, by the server, video information from the terminal;
converting, by the server, a voice signal included in the video information into text; and
generating, by the server, dubbing information based on the converted text,
wherein the text is composed of IPA.

7. The method of claim 6, wherein the generating of the dubbing information includes:
generating dubbing information about the voice signal based on a translation result for the voice signal, and the converted text.

8. The method of claim 7, wherein the generating of the dubbing information includes:
based on the converted text:
converting the translation result into information composed of IPA; and
generating dubbing information based on the converted information.

9. The method of claim 8, further comprising:
removing the voice signal from the video information; and
combining the dubbing information.

10. The method of claim 9, wherein an AI model is a transformer.
